(19) United States
(12) Patent Application Publication
(10) Pub. No.: US 2018/0152399 A1
(43) Pub. Date: May 31, 2018

(54) Group Message Prompting Method and Apparatus for Instant Messaging Applications

(71) Applicant: Alibaba Group Holding Limited, Grand Cayman (KY)

(72) Inventors: Xinglin Ma, Hangzhou (CN); Hang Chen, Hangzhou (CN); Zhenhao WU, Hangzhou (CN)

(21) Appl. No.: 15/881,495

(22) Filed: Jan. 26, 2018

Related U.S. Application Data
(63) Continuation of application No. PCT/CN2016/090373, filed on Jul. 19, 2016.

(30) Foreign Application Priority Data
Jul. 28, 2015 (CN) 201510450940.5

(51) Int. Cl. H04L 12/58; H04L 29/08

(52) U.S. Cl. CPC H04L 51/04; H04L 67/26; H04L 51/18

(57) ABSTRACT

A method includes: receiving a group message pushed by a server; determining whether the group message is related to a special follow object of a currently logged-in user in the instant messaging application, there being a first correlation between the currently logged-in user and the special follow object in a preset relational dimension, the first correlation being different from a second correlation between the currently logged-in user and another object in the preset relational dimension; prompting the group message through a first prompting manner when the group message is related to the special follow object, the first prompting manner being different from a second prompting manner used for a group message not related to the special follow object. The techniques actively configure a special follow object and distinctively prompt related group messages, thereby preventing a user from missing the group messages related to the special follow object.

### CROSS REFERENCE TO RELATED PATENT APPLICATIONS

This application claims priority to and is a continuation of PCT Patent Application No. PCT/CN2016/090373, filed on 19 Jul. 2016, which claims priority to Chinese Patent Application No. 201510450940.5, filed on 28 Jul. 2015, entitled “Group Message Prompting Method and Apparatus for Instant Messaging Applications,” which are hereby incorporated by reference in their entirety.

### TECHNICAL FIELD

The present disclosure relates to the field of communication technology, and, more particularly, to a group message prompting method and apparatus for instant messaging applications.

### BACKGROUND

With the continuous development of mobile technology, instant messaging has become a very important means of communication. Furthermore, with more and more functions being integrated in instant messaging applications, instant messaging applications have gradually been applied to people's daily life, study, work, etc.

An instant messaging application provides a group function, and multiple users may speak and discuss in the same group to improve the efficiency of information exchange.

However, since there are many users in the group and many group messages are generated therewith, continuous group message notifications may adversely affect the user and worsen user experience of using the instant messaging application.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure. The present disclosure provides a method and device for multi-display interaction, which makes the interaction process more vivid and real, which improves the user engagement. In view of this, the present disclosure provides a group message prompting method and apparatus for an instant messaging application, which enables the instant messaging application to actively configure a special follow object and distinctively prompt group messages related to the special follow object, to prevent the user from missing the group messages related to the special follow object.

The present disclosure provides the following technical solutions.

According to a first aspect of the present disclosure, a group message prompting method for instant messaging applications is provided, which includes:

receiving a group message pushed by a server;

determining whether the group message is related to a special follow object of a currently logged-in user in the instant messaging application; wherein there is a first correlation between the currently logged-in user and the special follow object in a preset relational dimension, and the first correlation is different from a second correlation between the currently logged-in user and another object in the preset relational dimension;

prompting the group message through a first prompting manner when the group message is related to the special follow object, wherein the first prompting manner is different from a second prompting manner used for the group message not related to the special follow object.

According to a second aspect of the present disclosure, a group message prompting apparatus for instant messaging application is provided, which includes:

a receiving unit that receives a group message pushed by a server;

a determining unit that determines whether the group message is related to a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension;

a prompting unit that prompts the group message through a first prompting manner when the group message is related to the special follow object, wherein the first prompting manner is different from a second prompting manner used for the group message not related to the special follow object.

According to a third aspect of the present disclosure, a message prompting method for instant messaging applications is provided, which includes:

receiving a communication message pushed by a server, wherein the communication message is sent by a pre-correlated user and has a plurality of receiving users;

determining whether the communication message is related to a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension;

prompting the communication message through a first prompting manner when the communication message is related to the special follow object, wherein the first prompting manner is different from a second prompting manner used for the communication message not related to the special follow object.

According to a fourth aspect of the present disclosure, a message prompting apparatus for instant messaging application is provided, which includes:

a receiving unit that receives a communication message pushed by a server, wherein the communication message is sent by a pre-correlated user and has a plurality of receiving users;

a determining unit that determines whether the communication message is related to a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension;

a prompting unit that prompts the communication message through a first prompting manner when the communication message is related to the special follow object, wherein the first prompting manner is different from a second prompting manner used for the communication message not related to the special follow object.

According to a fifth aspect of the present disclosure, a message prompting method for instant messaging applications is provided, which includes:

receiving a notification message pushed by a server, wherein the notification message is related to preset operation executed by a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension;

prompting the notification message through a first prompting manner, wherein the first prompting manner is different from a second prompting manner used for the group message not related to the special follow object.

According to a sixth aspect of the present disclosure, a message prompting apparatus for instant messaging application is provided, which includes:

a receiving unit that receives a notification message pushed by a server, wherein the notification message is related to preset operation executed by a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension;

a prompting unit that prompts the group message through a first prompting manner, wherein the first prompting manner is different from a second prompting manner used for the notification message not related to the special follow object.

As shown from the above technical solutions that in the present disclosure, by analyzing the correlation between the currently logged-in user and each subject, the special follow object of the currently logged-in user is extracted accurately, so that the group message related to the special follow object is distinctively prompted to ensure that the currently logged-in user detects the reception of the corresponding group message and view the group message in time.

### BRIEF DESCRIPTION OF THE DRAWINGS

In order to illustrate the technical solutions in the example embodiments of the present disclosure or conventional technologies more clearly, the drawings for illustrating the example embodiments are briefly introduced as follows. Apparently, the drawings in the following description are only some of the embodiments of the present disclosure. One of ordinary skill in the art may obtain other figures according to the FIGs without using creative efforts.

FIG. 1 is an interface diagram of a group management according to related technologies;

FIG. 2 is a flowchart of a group message prompting method for instant messaging applications according to an example embodiment of the present disclosure;

FIG. 3 is a flowchart of another group message prompting method for instant messaging applications according to an example embodiment of the present disclosure;

FIG. 4(A)-4(B) are diagrams of enterprise organizational structure according to an example embodiment of the present disclosure;

FIG. 5-9 are interface diagrams of an instant messaging application according to an example embodiment of the present disclosure;

FIG. 10 is a flowchart of another group message prompting method for instant messaging applications according to an example embodiment of the present disclosure;

FIG. 11-12 are interface diagrams of another instant messaging application according to an example embodiment of the present disclosure;

FIG. 13 is a structural diagram of an electronic device according to an example embodiment of the present disclosure;

FIG. 14 is a diagram of a group message prompting apparatus for instant messaging application according to an example embodiment of the present disclosure;

FIG. 15 is a flowchart of a message prompting method for instant messaging applications according to an example embodiment of the present disclosure;

FIG. 16 is an interface diagram of another instant messaging application according to an example embodiment of the present disclosure;

FIG. 17 is a structural diagram of an electronic device according to an example embodiment of the present disclosure;

FIG. 18 is a diagram of a message prompting apparatus for instant messaging application according to an example embodiment of the present disclosure;

FIG. 19 is a flowchart of another message prompting method for instant messaging applications according to an example embodiment of the present disclosure;

FIG. 20-23 are interface diagrams of another instant messaging application according to an example embodiment of the present disclosure;

FIG. 24 is a structural diagram of another electronic device according to an example embodiment of the present disclosure; and

FIG. 25 is a diagram of another message prompting apparatus for instant messaging application according to an example embodiment of the present disclosure.

### DETAILED DESCRIPTION

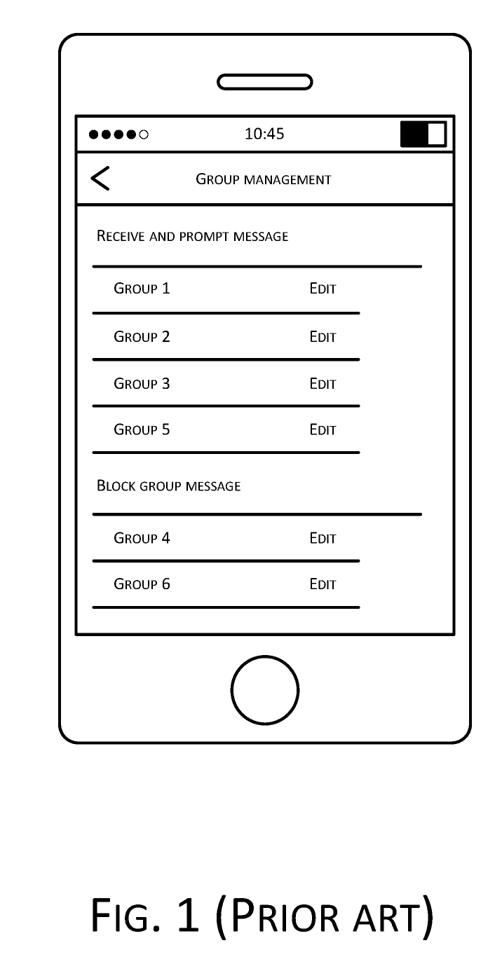

FIG. 1 is an interface diagram of a group management according to related technologies. As shown in FIG. 1, in order to prevent a large number of group messages from interfering with the user (especially when the user participates in many groups at the same time), an instant messaging application in related technologies provides a feature to block the group messages from a group. For example, in FIG. 1, group messages from group 1, group 2, group 3, and group 5 are received and prompted normally, however, group messages from group 4 and group 6 are blocked, and group messages from group 4 and group 6 do not interfere with the user.

However, in related technologies, the whole group is taken as an entirety, that is, the user is only allowed to completely block all group messages from the entire group, resulting in that the user may miss important messages from the groups.

Therefore, by improving the prompting process of the group message, the present disclosure solves the above technical problems existing in the related technologies and ensures that the user receives important group messages. To further illustrate the present disclosure, the following example embodiments are provided:

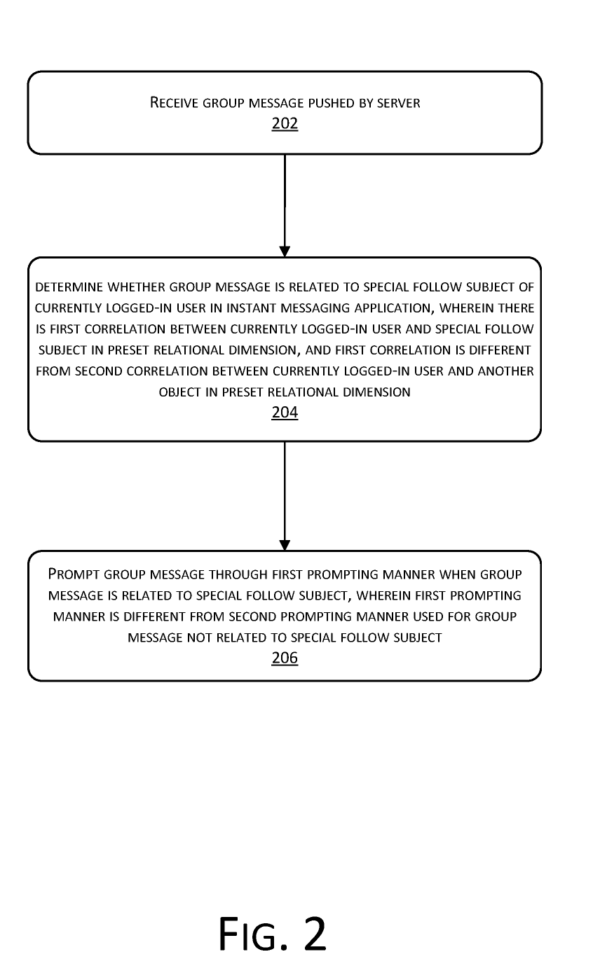

FIG. 2 is a flowchart of a group message prompting method for instant messaging applications according to an example embodiment of the present disclosure. As shown in FIG. 2, the method is applied to mobile devices and includes the following procedures:

202: A group message pushed by a server is received.

In this example embodiment, an instant messaging application may be any application that may implement “instant messaging.” For example, the instant messaging application may be an Enterprise Instant Messaging (EIM), such as an Enterprise Instant Messaging application “DingTalk”.

204: Whether the group message is related to a special follow object of a currently logged-in user in the instant messaging application is determined, wherein there is a first correlation between the currently logged-in user and the special follow object in a preset relational dimension, and the first correlation is different from a second correlation between the currently logged-in user and another object in the preset relational dimension.

In this example embodiment, different users may use the same mobile device, and the mobile device may identify and determine the identity information of the currently logged-in user according to the registered account that each user logs in.

In this example embodiment, according to the correlation between the currently logged-in user and each object in the preset relational dimension, the special follow object of the currently logged-in user is automatically distinguished and identified without manual selection and setting by the currently logged-in user, which helps to simplify user's actions and improve the accuracy of the special follow object.

206: the group message is prompted through a first prompting manner when the group message is related to the special follow object, wherein the first prompting manner is different from a second prompting manner used for the group message not related to the special follow object.

In this example embodiment, a distinctive prompt for receiving the group message related to the special follow object achieves better prompt function, ensures the currently logged-in user to detect and view the corresponding group message in time and avoid missing the group message.

In the example embodiments of the present disclosure, a mobile device or a server may automatically distinguish and identify a special follow object corresponding to a currently logged-in user according to the correlation between the currently logged-in user and each object in the preset relational dimension. The technical solutions of the present disclosure are described in detail below with respect to the identification process of the special follow object and the type of the preset relational dimension.

### First Example Embodiment

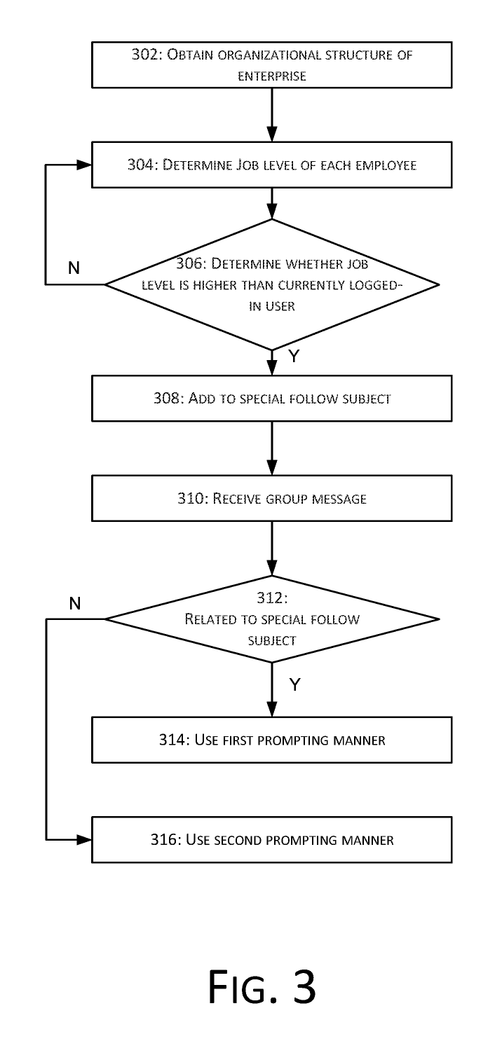

FIG. 3 is a flowchart of a group message prompting method for an instant messaging application according to an example embodiment of the present disclosure. As shown in FIG. 3, the method is applied to a mobile device and may include the following procedures:

302: An organizational structure of an enterprise to which a currently logged-in user belongs is obtained.

In this example embodiment, a preset relational dimension includes a member structure of a group to which a currently logged-in user belongs. The “group” specifically includes an enterprise, an organization, etc. If there are multiple members and an organizational structure, the group may apply to the embodiments of the present disclosure. Then, in this example embodiment, “enterprise” and the corresponding “enterprise organizational structure” are taken as an example for description.

304: The job level of each employee according to the organizational structure of the enterprise is determined.

306: Whether the job level of each employee of the enterprise is higher than the currently logged-in user is determined. If a result is positive, 308 is performed; otherwise, the process continues to determine next employee.

308: An employee whose job level is higher than that of the currently logged-in user is added as a special follow object of the currently logged-in user.

In this example embodiment, the mobile device may obtain the correlation between the currently logged-in user and all the enterprise employees according to the organizational structure of the enterprise, and determine the special follow object accordingly, wherein the correlation between the special follow object and the currently logged-in user is the first correlation, and the correlation between another object and the currently logged-in user is the second correlation.

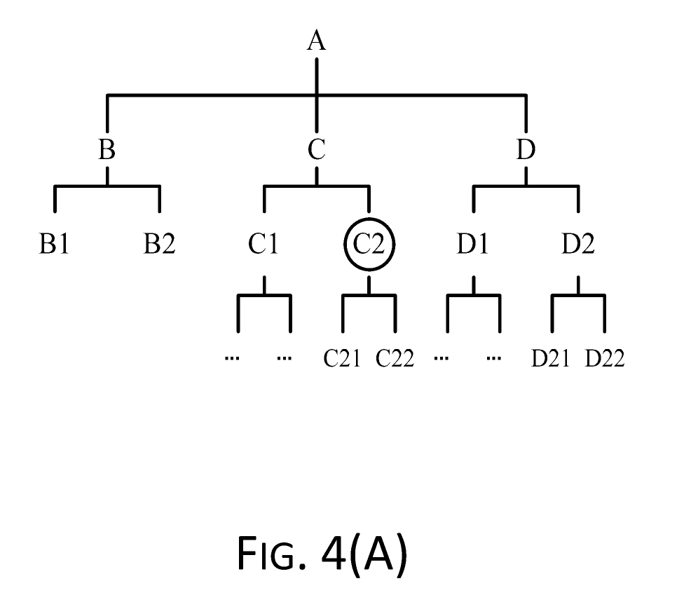

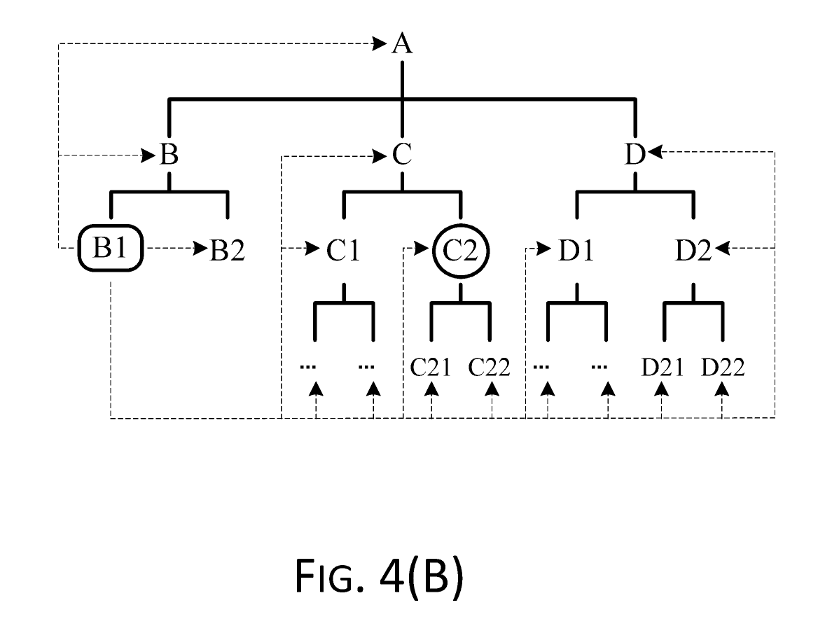

In an example embodiment, the correlation may be a job level relationship between employees of the enterprise; wherein the first correlation is that the job level of the special follow object is higher than that of the currently logged-in user, and the second correlation is that the job level of the object is not higher than the currently logged-in user. In an organizational structure, especially in an organizational structure of an enterprise, an employee, whose level is higher than that of the currently logged-in user, is the leader of the currently logged-in user. Since the leader is likely to send management commands or notifications in a group, the leader should be automatically added as a special follow object so that the currently logged-in user may effectively pay special concern to group messages issued by the leader, to avoid missing messages. Take the enterprise organizational structure shown in FIG. 4A as an example, if the currently logged-in user is C2, then A, B, C, and D should be added as special follow objects of user C2; as for B1, B2, C1, D1, and D2, etc., which have the same level as C2, as well as C21, C22, D21, and D22, etc., which have the lower level than C2, there is no importance or necessity between the upper and lower levels with respect to C2, and thus they may not be automatically added as special follow objects.

It should be noted that: based on the organizational structure of the enterprise, in addition to the job level, there are many other correlations between employees in the enterprise, and these correlations may be considered to determine whether an employee need to be added as a special follow object of the currently logged-in user.

For example, in another example embodiment, a special follow object is automatically added based on a correlation of the work content of the employees. Specifically, take FIG. 4A as an example again, assuming that the currently logged-in user C2 oversees the market in the enterprise, although the job level of C21 is lower than C2, since C21 is also responsible for the market or the work content is market-related, which means C21 does the consistent (same or similar) work as C2 does, so C21 is still added as a special follow object of C2.

In another example embodiment, an organizational structure of an enterprise also reflects the synergic relationship of the work content among the employees of the enterprise. As shown in FIG. 4B, the organizational structure of an enterprise includes not only the same “job level relationship” (shown in solid line) as in FIG. 4A, such as A having a job level higher than B, C, and D, and B having a job level higher than B1 and B2 etc., but also includes “job synergic relationship” (shown in broken line). For example, since there is a synergic relationship between B1 and all the other employees due to B1's position of “finance” or “human resources” etc., the mobile device also automatically adds B1 and another employee who has similar synergic relationship as special follow object of the currently logged-in user C2.

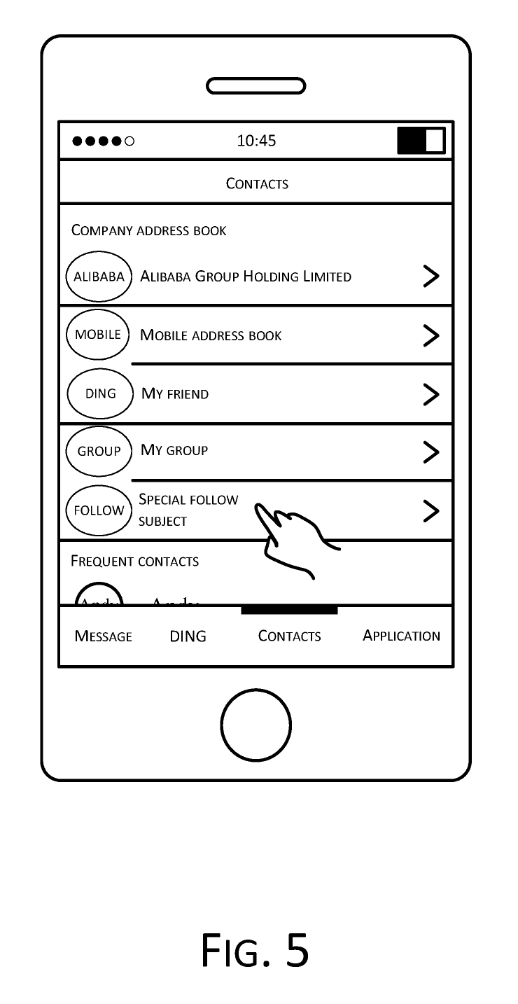

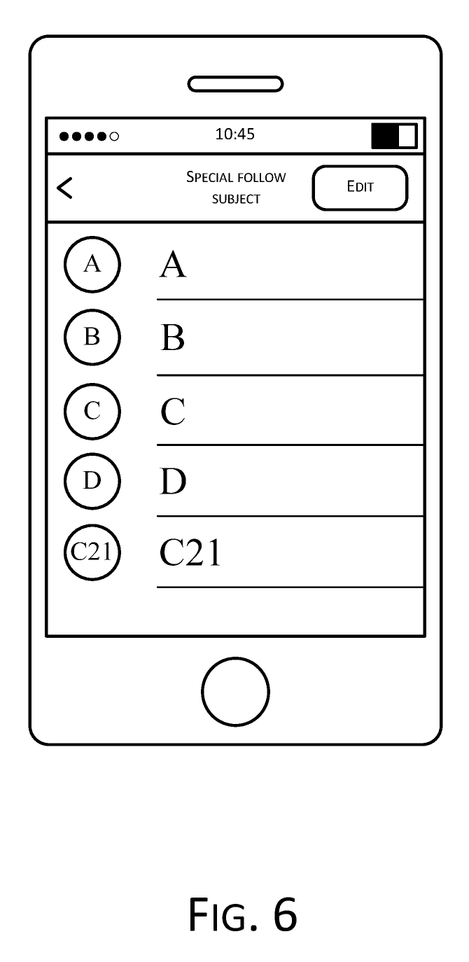

For those who have been added as special follow objects, the currently logged-in user may view them in the instant messaging application. As shown in FIG. 5, the currently logged-in user may view the “special follow object” option on the “contacts” page, and then trigger (for example, click) this option to go to the display page of the special follow object shown in FIG. 6. A, B, C, etc. are automatically added as special follow objects. At the same time, the “Edit” function is provided in the upper right corner of the page shown in FIG. 6, so the user may filter the automatically-added special follow objects, and may manually add the objects that the user is interested in but not automatically added as the special follow objects.

310: A group message pushed by a server is received.

312: Whether the received group message is related to the special follow object is determined. If a result is positive, the process proceeds to 314; otherwise, the process proceeds to 316.

In this example embodiment, the mobile device determines whether the group message is related to a special follow object by determining whether the sender of the group message is a special follow object; wherein if the sender is a special follow object, determining the message is relevant, otherwise, the message is irrelevant or needs to be determined with other conditions.

For example, both the currently logged-in user and the special follow object A belong to the group “Alibaba Group Holding Ltd.”, when the group receives a group message sent by A, the group message is determined to be related to the special follow object A.

314: A first prompting manner is used for prompt.

316: A second prompting manner is used for prompt.

In this example embodiment, the first prompting manner and the second prompting manner are respectively executed in any way, as long as the two manners are distinguished from each other. The prompting strength of the first prompting manner is higher than that of the second prompting manner to achieve a better prompting effect and ensure that the currently logged-in user does not miss the group message. For example, the first prompting manner is a combination of a prompting tone, vibration, and displaying the group message on the lock screen interface of the mobile device, and the second prompting manner is only that the group message is displayed on the lock screen interface of the mobile device only. The first prompting manner obviously achieves a better prompting effect.

Furthermore, distinctive display of the group messages related to the special follow object may be implemented by optimizing the display manner of the group messages, and to help the currently logged-in user to view the group messages efficiently. The optimized methods may include:

1. Stick Messages to the Top

As an example embodiment, a group message related to a special follow object may be stuck to the top on a message prompting page of the instant messaging application.

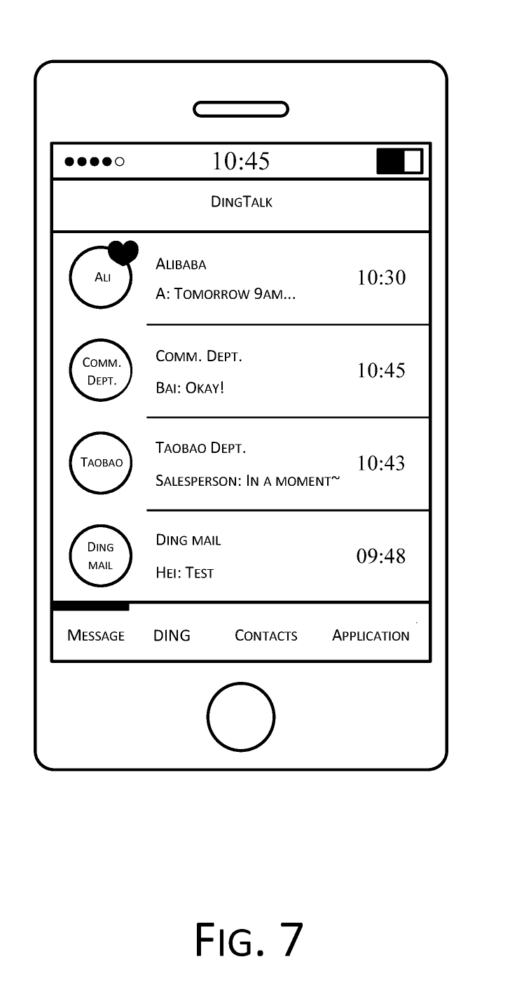

Take enterprise instant messaging application “DingTalk” for an example. As shown in FIG. 7, on the message prompting page, usually the messages are sorted according to the receiving time, such as the most recently (that is, the latest) received message is placed on the top; however, when the received group message is related to a special follow object, such as there is a group message sent by user A “Tomorrow morning 9:00 AM . . . ” in the group “Alibaba Group Holdings Ltd.” in FIG. 7, although the group message is received at 10:30, it is still placed above the group message received at 10:45 in “Communication Department” group and the group message received at 10:43 in “Taobao Department” group, i.e., it is stuck to the top.

In the meantime, in order to show the difference between group messages related to the special follow object and other group messages, a category identifier is added to the message prompting page. As shown in FIG. 7, by adding the category identifier “♥” to the icon of the group “Alibaba Group Holdings Ltd.”, the currently logged-in user may quickly distinguish there are group messages related to the special follow object in the group “Alibaba Group Holdings Ltd.” Certainly, other types of category identifiers may also be used, which are not limited in the present disclosure.

2. Page Adjustment

As an example embodiment, an adjustment may be made to the display page of the group message, which includes: when the display page of the group message is triggered, if there is an unread group message related to the special follow object, displaying the unread group message. In this example embodiment, by actively determining whether there is an unread group message related to a special follow object and then displaying the unread group message, it is convenient for the currently logged-in user to view quickly, to avoid missing the group message related to a special follow object while browsing other group messages.

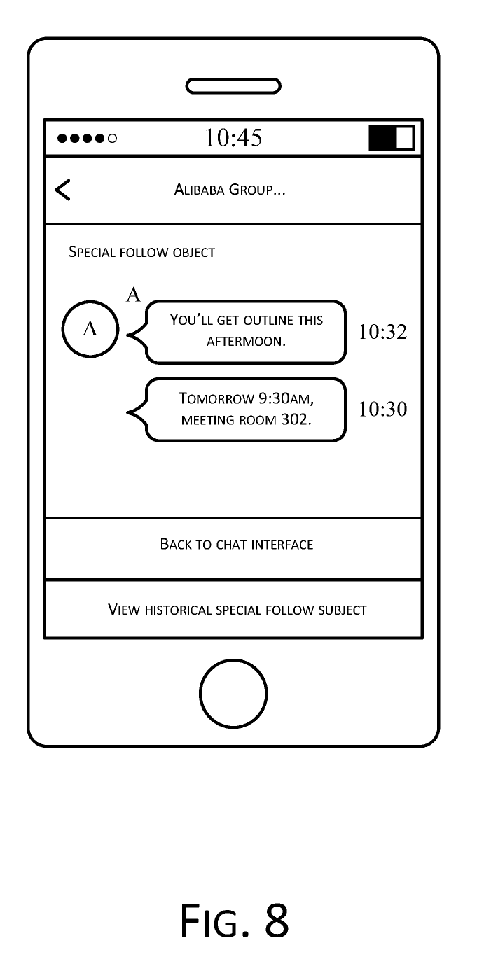

In an example embodiment, all unread group messages related to a special follow object are extracted and displayed concentratedly. For example, when a display page of a group “Alibaba Group Holdings Ltd.” is triggered, assuming that there are two unread group messages sent by user A, the two group messages are displayed concentratedly on a display page shown in FIG. 8, to facilitate the currently logged-in user for concentrated view. Furthermore, on the display page shown in FIG. 8, the currently logged-in user may choose to return to the chat interface, and then the mobile device returns to the normal chat interface (i.e., the display page of group messages) of the group “Alibaba Group Holding Ltd.” from the display page shown in FIG. 8; or the currently logged-in user may also select to view the historical special follow messages, that is, the historical group messages related to the special follow object received by the group “Alibaba Group Holding Ltd.”.

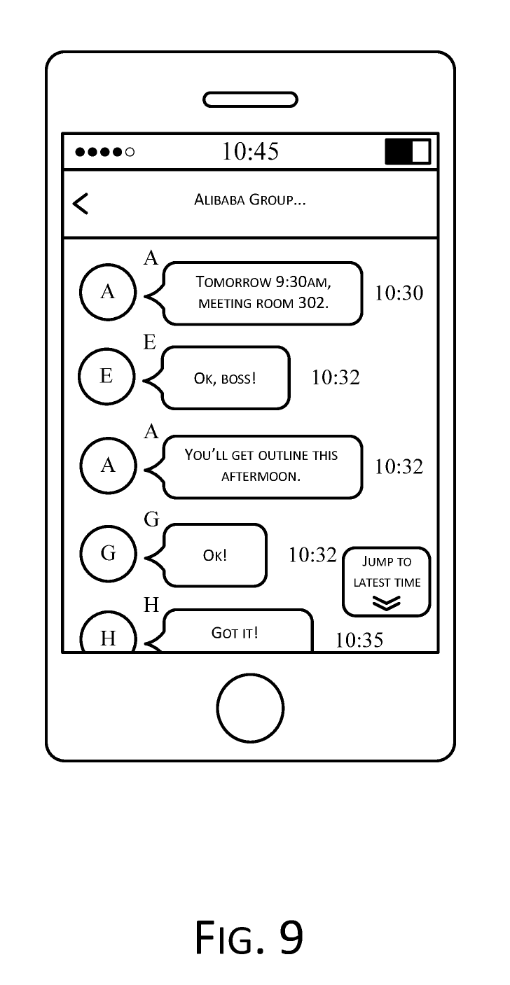

In another example embodiment, the display page may be jumped to an unread group message related to a special follow object. For example, as shown in FIG. 9, after opening the display page of the group message in the group “Alibaba Group Holdings Ltd.”, assuming that there are two unread group messages sent by the user A, the mobile device actively jumps from the display page to the earliest unread group message related to the special follow object A, that is, the group message “Tomorrow morning 9:30, meeting in room 302!” received at 10:30 as shown in FIG. 9. By automatically switching the display page, the currently logged-in user may easily understand the content of the unread group message by combining the context where the unread group message is located.

In FIG. 9, a jump icon is also provided in a lower-right corner of the screen interface to perform a function of “Jump to the latest time”, that is, a direct jump from the current position to the display position of the recently received group message. The user doesn't need to operate manual paging repeatedly. In the case of a large number of messages, it facilitates the user to operate simply and improves browsing efficiency.

### A Second Example Embodiment

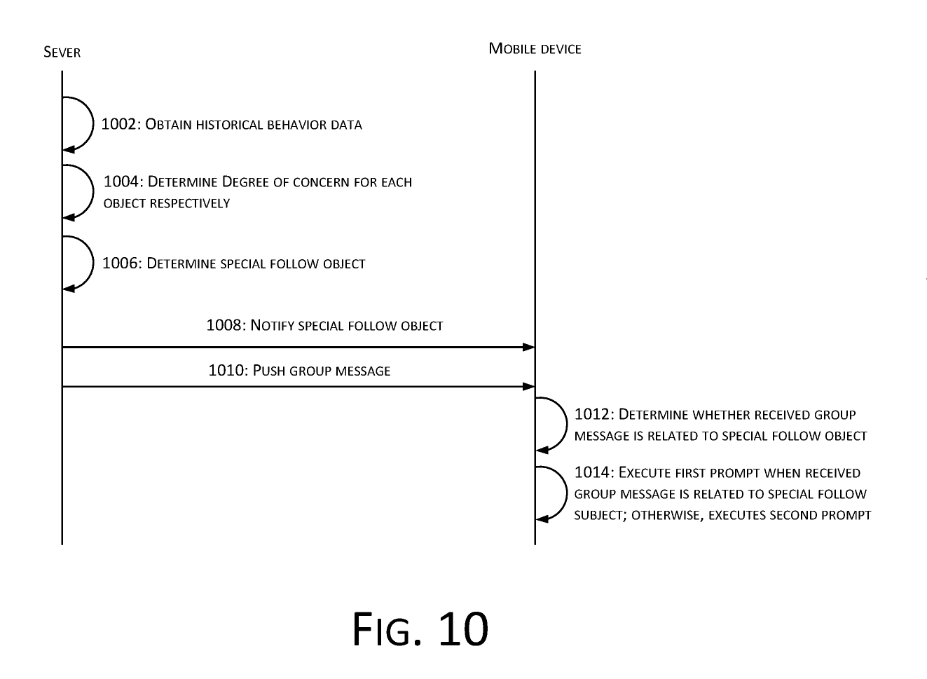

FIG. 10 is a flowchart of a group message prompting method for instant messaging applications according to an example embodiment of the present disclosure. As shown in FIG. 10, the method includes the following procedures:

1002: A server obtains the historical behavior data of each user.

1004: The server determines the degree of concern for each object respectively for each user by analyzing the historical behavior data.

In this example embodiment, the historical behavior data may include data related to any historical behavior of the user. For example, the historical behavior data may include at least one of the following data: a browsing history, a favorite history, or a purchase history on an e-commerce website, and joined group information in the instant messaging application, offline consumption records, etc. Through the analysis of historical behavior data, each user's interests, hobbies, etc. may be understood, then the user's degree of concern for corresponding object may be understood. For example, assuming that a user purchases badminton rackets and similar products on an e-commerce website, adds groups such as “Ali Sports Team” to an instant messaging application, and often consumes at a gymnasium, a gym, or the like in spare time, the server may determine that the user is very interested in sports, that is, the user's degree of concern for the object “sports” is very high.

Certainly, the server may further analyze according to the user's other information to determine the special follow object, which is not limited in the present disclosure. For instance, the server may analyze according to the work content of the user; for one example, assuming that the work content of the user is responsible for marketing, then the server determines that the user has a high degree of concern for the object “market”.

1006: The server determines special follow object according to the degree of the user's concern for each object; wherein the special follow object is an object whose degree of concern reaches a preset degree of concern.

In this example embodiment, in one scenario, “reaching the preset degree of concern” may be understood as follows: the server takes the “degree of concern” as a parameter for counting and calculating, and the preset degree of concern is a preset parameter value, then when the server counts and calculates that the value of the user's concern for an object reaches the preset parameter value, it is determined that the object is a special follow object.

Or, in another scenario, “reaching the preset degree of concern” may be understood as follows: the server sorts the user's concerns for all the objects, and then sequentially selects the preset number of objects from the front to the back, and determines the selected objects as special follow objects.

1008: For the currently logged-in user on the mobile device, the server notifies the mobile device of the special follow object corresponding to the currently logged-in user.

1010: The serer pushes the group message to the mobile device.

1012: The mobile device determines whether the received group message is related to a special follow object.

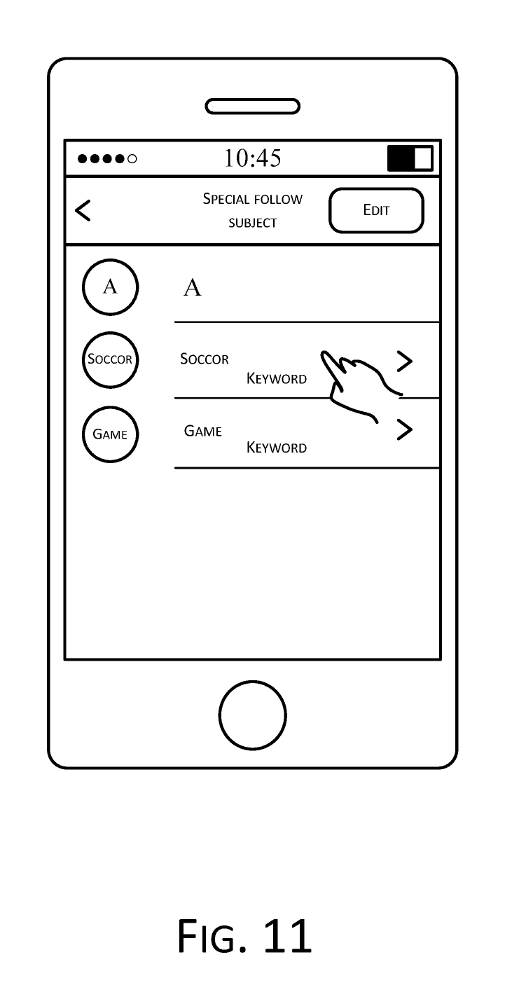

In this example embodiment, when the special follow object is identified and obtained by the server depending on “the relational dimension of the degree of the currently logged-in user's concern for each object”, the mobile device determines whether the received group message is related to the special follow object by determining whether there are keywords related to the special follow object in the content of the group message. For example, as shown in FIG. 11, the currently logged-in user may view the existing special follow object in the special follow object display page. For example, the special follow object in FIG. 11 includes “contact person A”, and “soccer” and “game”.

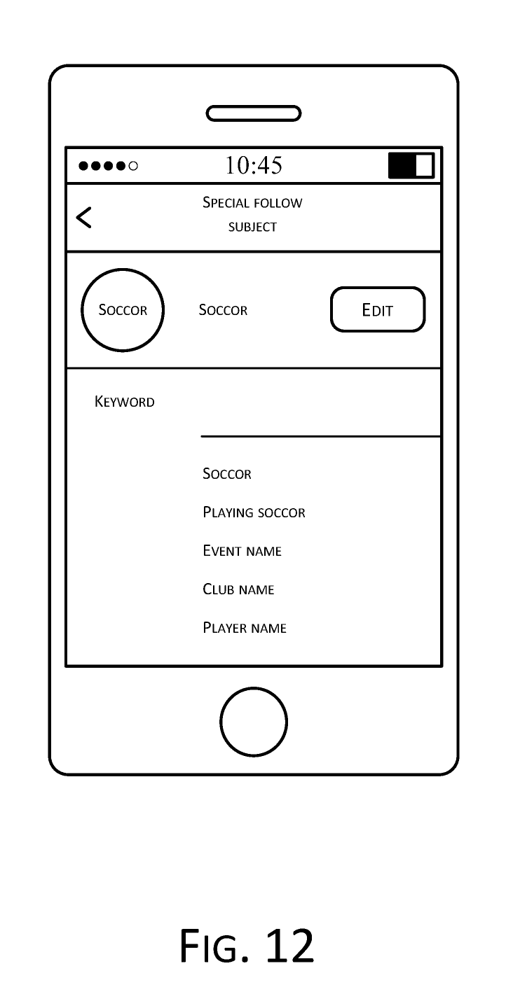

Furthermore, the currently logged-in user may also view the corresponding keywords by selecting the special follow object. For example, when the user clicks on “soccer” in FIG. 11, the user may switch to the keyword viewing page shown in FIG. 12 and check those keywords related to “soccer” including soccer, playing soccer, event name (name that includes a group of events such as “World Cup” and “European Cup” etc.), club name, player name, etc.; at the same time, the currently logged-in user may also add, delete or edit the keywords according to their actual needs.

1014: The mobile device executes a first prompt when the received group message is related to the special follow object; otherwise, executes a second prompt.

In this example embodiment, 1014 is similar to 314 and 316 shown in FIG. 3, which is not detailed herein for brevity. In addition, after 1014, with respect the trigger operation of the currently logged-in user, the group message sticking process shown in FIG. 7 and the group message displaying process shown in FIG. 8-9 may also be implemented, which is not described herein again.

It should be noted:

In the first example embodiment shown in FIG. 3, the mobile device identifies the special follow object of the currently logged-in user and the identification process depends on the relational dimension of the enterprise organizational structure; and in the second example embodiment shown in FIG. 10, the server identifies the special follow object of the currently logged-in user, and the identification process depends on the relational dimension of the degree of the currently logged-in user's concern for each object.

However, when the mobile device identifies the special follow object of the currently logged-in user, the identification process may also depend on the relational dimension of the degree of the currently logged-in user's concern for each object; similarly, when the server identifies the special follow object of the currently logged-in user, the identification process may also depend on the relational dimension of the enterprise organizational structure. In other words, the identification body of the special follow object of the currently logged-in user and the preset relational dimension which is depended on in the identification process may be freely selected and combined, which is not limited in the present disclosure.

In addition, enterprise organizational structure may change, and the currently logged-in user's behavior data will be continuously collected, then the mobile device or the server updates the special follow object corresponding to the currently logged-in user to make it consistent with the actual demand of the currently logged-in user.

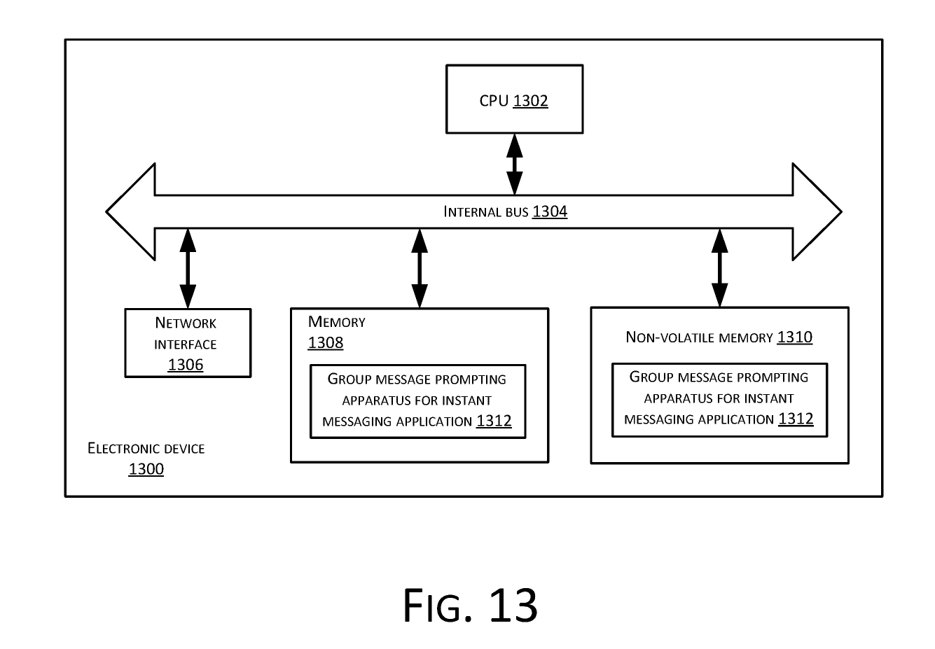

FIG. 13 is a structural diagram of an electronic device according to an example embodiment of the present disclosure. Referring to FIG. 13, as for hardware, the electronic device 1300 includes a processor 1302, an internal bus 1304, a network interface 1306, a memory 1308, and a non-volatile memory 1310 and may also include hardware required by other services. The processor 1302 reads the corresponding computer program from the non-volatile memory 1310 into the memory 1308 and then runs to form a group message prompting apparatus for instant messaging application 1312 on the logic level. Certainly, this disclosure does not exclude other implementations other than the software implementation, such as logic devices or a combination of hardware and software, etc. That is, the execution object of the following processing flows is not limited to each logic unit, and may be hardware or logic device.

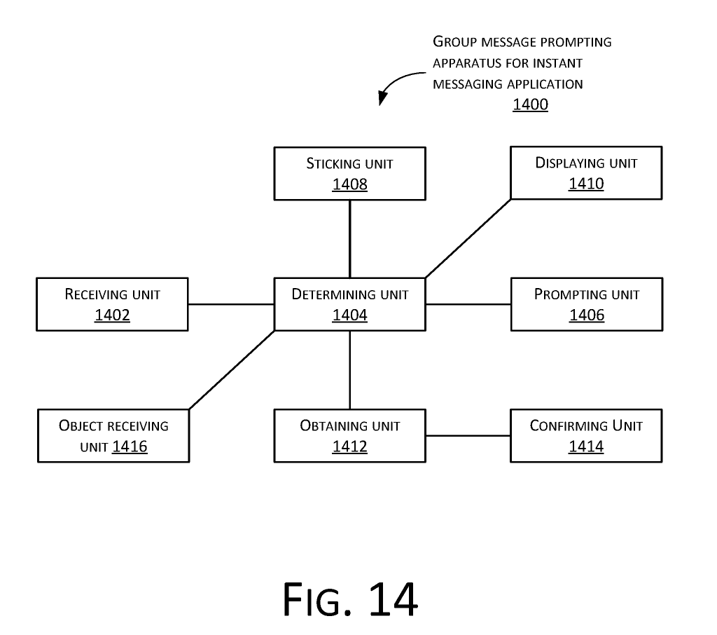

Referring to FIG. 14, in a software implementation, a group message prompting apparatus for instant messaging application 1400 includes a receiving unit 1402, a determining unit 1404, and a prompting unit 1406, wherein:

the receiving unit 1402 receives a group message pushed by a server;

the determining unit 1404 determines whether the group message is related to a special follow object of a currently logged-in user in the instant messaging application; wherein there is a first correlation between the currently logged-in user and the special follow object in a preset relational dimension, and the first correlation is different from a second correlation between the currently logged-in user and another object in the preset relational dimension; and

the prompting unit 1406 prompts the group message through a first prompting manner when the group message is related to the special follow object, wherein the first prompting manner is different from a second prompting manner used for the group message not related to the special follow object.

Optionally, the preset relational dimension includes at least one of the following:

a membership structure of the organization to which the currently logged-in user belongs, and the degree of the currently logged-in user's concern for each object.

Optionally, when the preset relational dimension is the membership structure, the special follow object is a member of the organization, and the correlation between the special follow object and the currently logged-in user meets at least one of the following:

the job level of the special follow object is higher than that of the currently logged-in user in the membership structure;

the work content of the special follow object is consistent with the work content of the currently logged-in user;

the work content of the special follow object cooperates with the work content of the currently logged-in user.

Optionally, the determining unit 1404 may further determine whether the sender of the group message is the special follow object.

Optionally, when the preset relational dimension is the degree of concern, the special follow object is the object whose degree of concern from the currently logged-in user reaches a preset degree of concern.

Optionally, the determining unit 1404 further determines whether the content of the group message includes the keyword related to the special follow object.

Optionally, the special follow object is determined by at least one of the following information about the currently logged-in user: work content, historical behavior data.

Optionally, the group message prompting apparatus for instant messaging application 1400 also includes a sticking unit 1408 that sticks the group message related to the special follow object on the message prompting page of the instant messaging application.

Optionally, the group message prompting apparatus for instant messaging application 1400 also includes a displaying unit 1410 that displays the unread group message if there is an unread group message related to the special follow object when the display page of the group message is triggered.

Optionally, the display uniting 1410 may further extract all the unread group messages related to the special follow object and display them concentratedly, or, move the display page to an unread group message related to the special follow object.

Optionally, the group message prompting apparatus for instant messaging application 1400 also includes an obtaining unit 1412 that obtains a correlation between the currently logged-in user and all objects in a preset relational dimension; and a confirming unit 1414 that determines the special follow object; the correlation between the special follow object and the currently logged-in user is the first correlation, and the correlation between other objects and the currently logged-in user is the second correlation.

Optionally, the group message prompting apparatus for instant messaging application 1400 also includes an object receiving unit 1416 that receives a special follow object of the currently logged-in user pushed by a server, wherein the special follow object is determined by the server according to a correlation between the currently logged-in user and all objects in the preset relational dimension.

Optionally, the instant messaging application is an enterprise instant messaging application.

In the above example embodiment, the processing object is a group message received by the instant messaging application, but the processing object of the present disclosure is obviously not limited thereto; in fact, any message similar to the “group message” may implement corresponding message prompt, as long as the communication message received by the instant messaging application meets the following conditions: the sender is the pre-correlated user of the currently logged-in user (for example, a contact in an instant messaging application, a colleague in the same enterprise, etc.) and the recipient are multiple users (including the currently logged-in user).

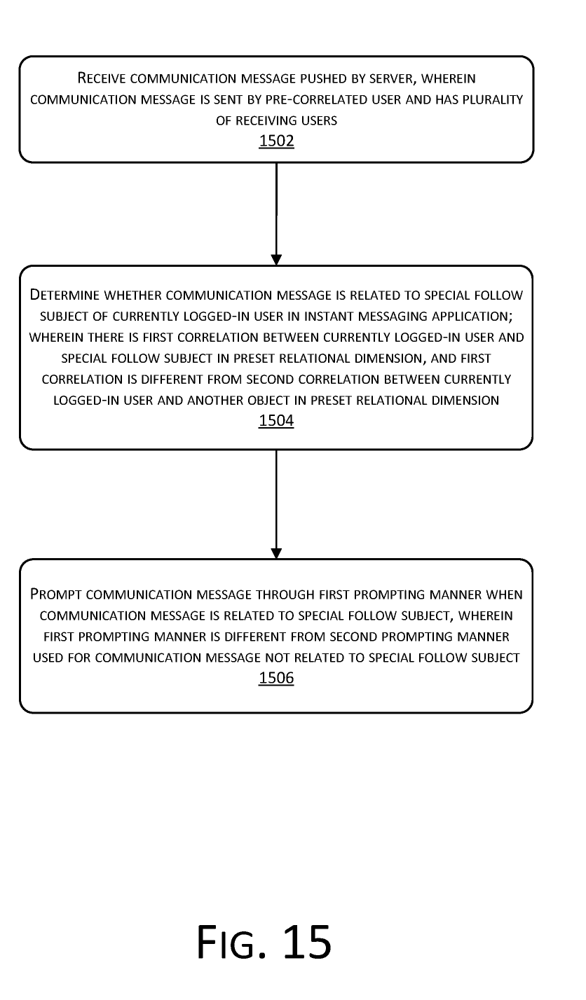

Specifically, FIG. 15 is a flowchart of a message prompting method for instant messaging applications according to an example embodiment of the present disclosure. As shown in FIG. 15, the method is applied to a mobile device and includes the following steps:

1502: receiving a communication message pushed by a server, wherein the communication message is sent by a pre-correlated user and has a plurality of receiving users;

1504: determining whether the communication message is related to a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension; and

1506: prompting the communication message through a first prompting manner when the communication message is related to the special follow object, wherein the first prompting manner is different from a second prompting manner used for the communication message not related to the special follow object.

Compared with the foregoing example embodiments such as FIG. 2, this example embodiment extends the processing object from “group message” to a wider range of “communication message.” For other technical features, reference may be made to the foregoing embodiments, and details are not described herein again.

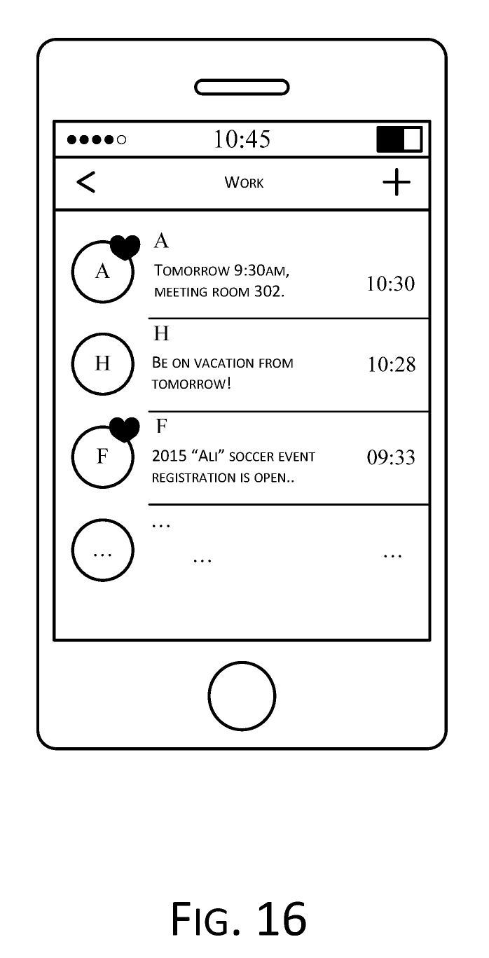

For better understanding and analogy to “group message,” “communication message” is illustrated below. In an example embodiment, “communication message” is the “work circle message” as shown in FIG. 16. In the “work circle” shown in FIG. 16, the currently logged-in user may send a “work circle message” and the pre-correlated user receives and views it as “public announcement,” “notice,” or “notification.” Meanwhile, the currently logged-in user may also receive and view the “working circle message” sent by the pre-correlated user, for example, in FIG. 16, user A, user H, and user F are pre-correlated users of the currently logged-in user. Wherein, the pre-correlated user refers to a user who has already built a correlation with the currently logged-in user. For example, the pre-correlated user is a contact of a currently logged-in user in an instant messaging application, an enterprise colleague of a currently logged-in user, or a user who has a working collaborative relationship with the currently logged-in user.

In one scenario, assuming that the job level of user A is higher than that of the currently logged-in user, then user A is added as a special follow object of the currently logged-in user. When user A posts work circle messages such as “Tomorrow morning 9:30, meeting in room 302!” which may be treated as a correlated message related to the special follow object and prompted in a distinctive manner.

In another scenario, assuming that the currently logged-in user has a higher degree of concern for “soccer” than the preset degree of concern, so that “soccer” is added as a special follow object of the currently logged-in user. Then, after user F (or any other user) posts a work circle message such as “2015 Ali soccer event registration is open . . . ”, the mobile device may determine that the work circle message is related to the special follow object according to the keyword “soccer” in the work circle message and execute a distinctive prompt.

In addition, on the display page of the work circle message shown in FIG. 16, the currently logged-in user may conveniently identify these messages when a “♥” identifier is added to the work circle message related to the special follow object. Certainly, in the foregoing example embodiment of “group message”, the various display methods and prompting methods of the group message provided may be applied here, which is not described herein again.

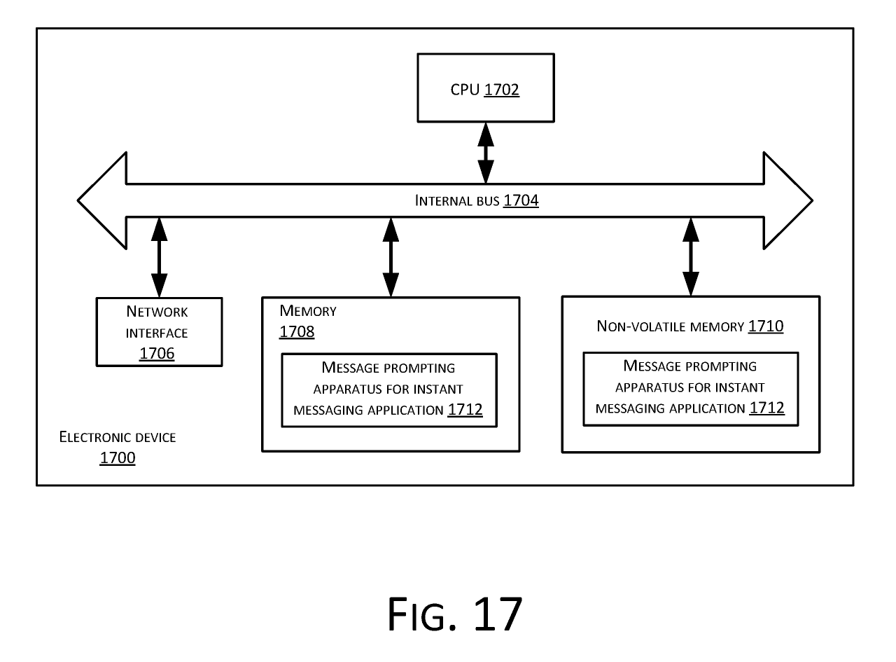

FIG. 17 shows a structural diagram of an electronic device 1700 according to an example embodiment of the present disclosure. Referring to FIG. 17, as for hardware, the electronic device 1700 includes a processor 1702, an internal bus 1704, a network interface 1706, a memory 1708, and a non-volatile memory 1710, and may also include hardware required by other services. The processor 1702 reads the corresponding computer program from the non-volatile memory 1710 into the memory 1708 and then runs to form a message prompting apparatus for instant messaging application 1712 on the logic level. Certainly, this disclosure does not exclude other implementations other than the software implementation, such as logic devices or a combination of hardware and software, etc. That is, the execution object of the following processing flows is not limited to each logic unit, and may be hardware or logic device.

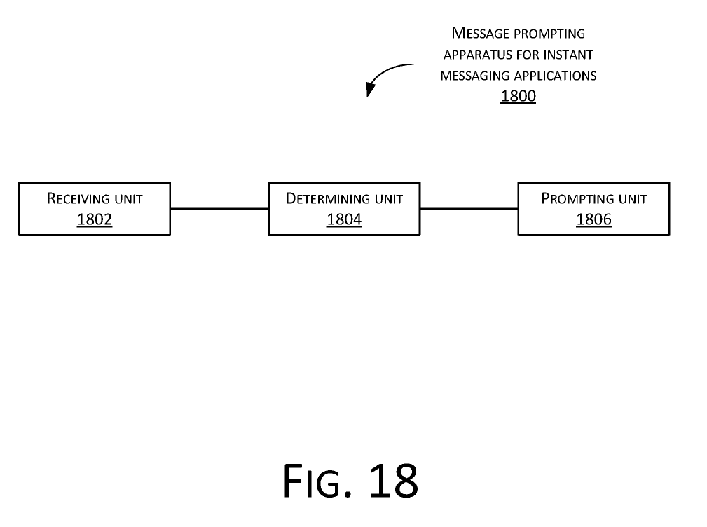

Referring to FIG. 18, in a software implementation, a message prompting apparatus for instant messaging application 1800 includes a receiving unit 1802, a determining unit 1804, and a prompting unit 1806, wherein:

the receiving unit 1802 receives a communication message pushed by a server, wherein the communication message is sent by a pre-correlated user and has a plurality of receiving users;

the determining unit 1804 determines whether the communication message is related to a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension; and

the prompting unit 1806 prompts the communication message through a first prompting manner when the communication message is related to the special follow object, wherein the first prompting manner is different from a second prompting manner used for the communication message not related to the special follow object.

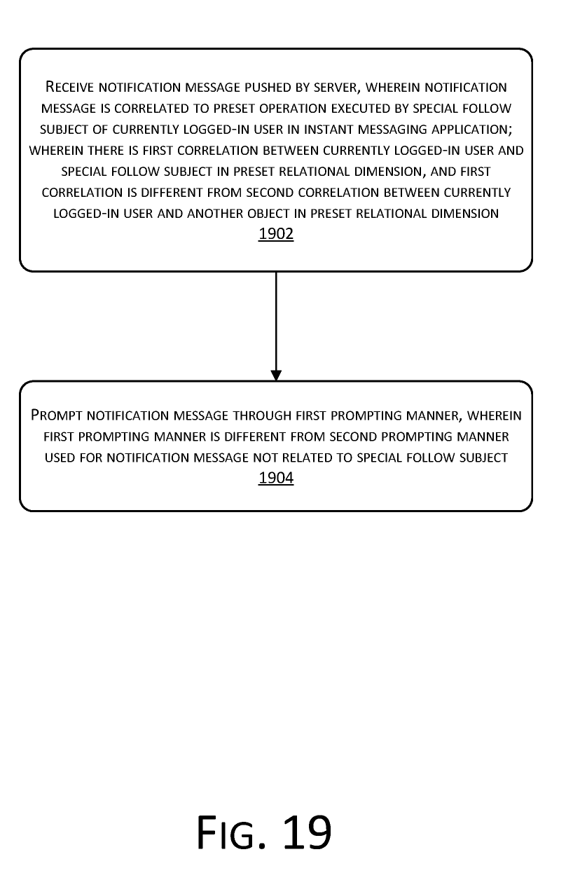

FIG. 19 is a flowchart of another message prompting method for instant messaging applications according to an example embodiment of the present disclosure. As shown in FIG. 19, the method is applied to a mobile device and includes the following procedures:

1902: receiving a notification message pushed by a server, wherein the notification message is correlated to preset operation executed by a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension;

1904: prompting the notification message through a first prompting manner, wherein the first prompting manner is different from a second prompting manner used for the group message not related to the special follow object.

In this example embodiment, the currently logged-in user wants to obtain more information about the special follow object, including the operation behavior of the special follow object. The currently logged-in user may determine the preset operation that the user is interested in, or may also determine the preset operation according to the default setting of the instant messaging application, so that after the special follow object executes the preset operation, the currently logged-in user may be notified about the notification message, to ensure that the currently logged-in user to know the related information.

For example, the operation object of the preset operation includes a mail system or a shared cloud disk space correlated to the instant messaging application. For example, for an enterprise instant messaging application “DingTalk”, a correlated mail system may be “DingMail” and the correlated shared cloud disk space may be the storage space in the “DingDisk”. Then for the mail system, the preset operation executed by the special follow object may be: sending mail to the currently logged-in user through the mail system; and for the shared cloud disk space, the preset operation executed by the special follow object may be as follows: updating files in the shared cloud disk space. Correspondingly, the notification message received by the currently logged-in user includes: the content of the email, or the information of the updated files in the shared cloud disk space.

1) Mail System

Assuming that the special follow object is A, when A sends an email to the currently logged-in user through “DingMail”, it is considered that a predefined “preset operation” is triggered and a notification message is sent to the currently logged-in user. Then, the instant messaging application prompts the notification message through a distinctive “first prompting manner”. The process includes the following procedures:

The notification message is used as an instant messaging message that uses the special follow object as the sender and the notification message is prompted, and at least one of the followings is displayed in the correlated display area of the notification message: a special follow identifier and an operation type identifier.

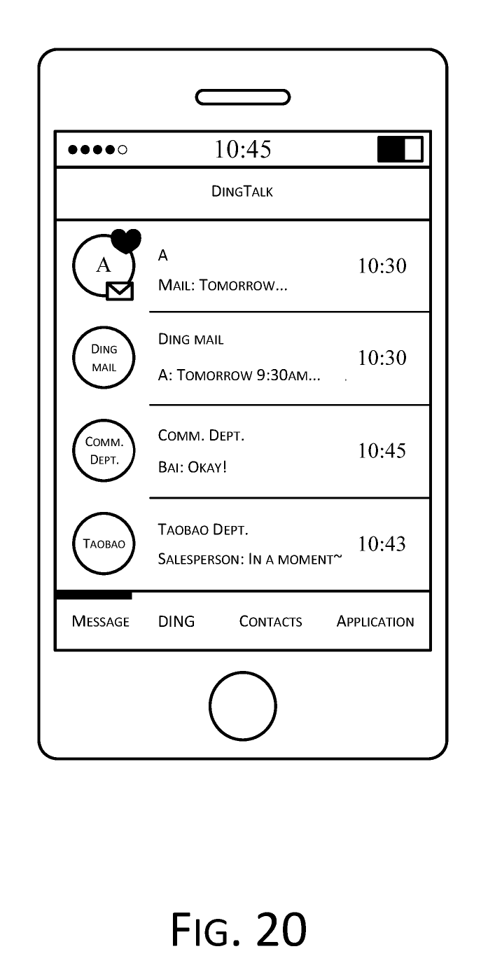

In this example embodiment, the notification message is actually the preset operation of the server for the special follow object, which is the server's prompting information for the currently logged-in user. However, since the executor of the preset operation is a special follow object, in order to enhance the correlation to the special follow object, the interval between “notification message” and “preset operation” is shortened. For example, as shown in FIG. 20, on the prompting page of “DingTalk”, the notification message is displayed in the correlated display area corresponding to the special follow object A, the currently logged-in user may view “message body: Tomorrow . . . ” and other information on the message prompting page to obtain partial contents of the notification message.

In the related display area corresponding to the special follow object A, special follow identifiers such as “♥” may be used to distinguish from other prompts. At the same time, by the operation type identifiers such as “envelope”, it is also possible to make the currently logged-in user know from FIG. 20: the preset operation executed by the special follow object A is that sending email to the currently logged-in user through the mail system.

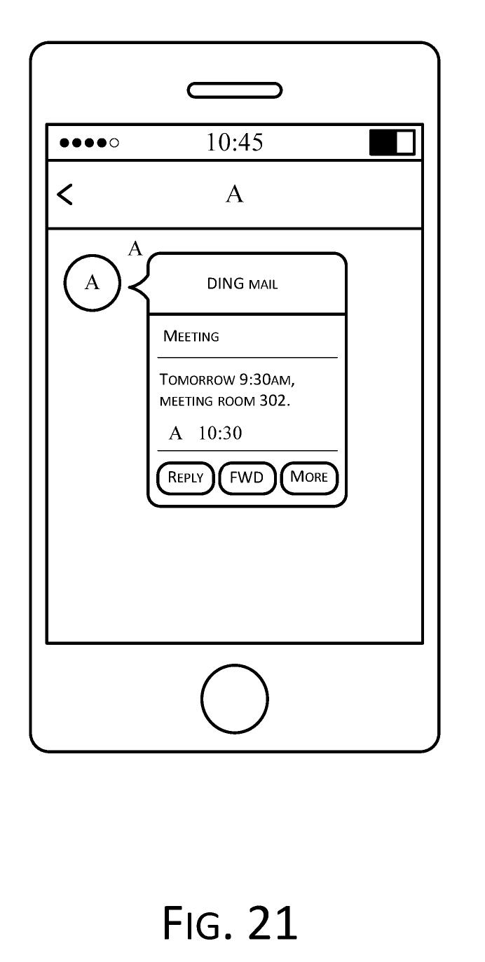

Furthermore, the content of the notification message is displayed in the message receiving window corresponding to the special follow object after the prompt is responded; a function icon for the content type is displayed according to the content type of the notification message; and the response operation for the preset operation is executed in the message receiving window according to the selected function icon. For example, if the currently logged-in user clicks on the correlated display area corresponding to the special follow object A in FIG. 20, it indicates that the corresponding prompt is responded and the page is switched to the message receiving window of the special follow object A shown in FIG. 21 and the content of the notification message is displayed by “bubble box” or other forms, such as in FIG. 21, the email content sent by A is displayed: “Tomorrow 9:30, meeting in Room 302,” and other information. Certainly, in the message receiving window shown in FIG. 21, the entire or partial content of the email may be displayed, which is related to the length of the email content, the predefined display strategy and the like.

In order to facilitate the operation of the currently logged-in user, since the content type of the notification message is email, some function icons for the email are shown, such as “reply”, “forward” and the like under the email content shown in FIG. 21. When the user clicks on these function icons, the corresponding functions may be directly executed in the current message receiving window, and doesn't need to switch to the processing page of the mail system, which helps to improve the user's operation efficiency. Certainly, the currently logged-in user may also choose to switch to the mail system to use the complete mail processing function, which is not limited in the present disclosure.

2) Shared Cloud Disk Space

Assuming that special follow object A initiates a file update operation for the shared cloud disk space, similar to the mail system, the server also sends a notification message to the currently logged-in user. The “shared cloud disk space” refers to the shared storage space of the currently logged-in user and the special follow subject A in the cloud disk space. For example, both the currently logged-in user and the special follow object A belong to a same enterprise group, which has a corresponding shared folder in the cloud disk space, then the shared folder is equivalent to a shared cloud disk space for all members of the enterprise group.

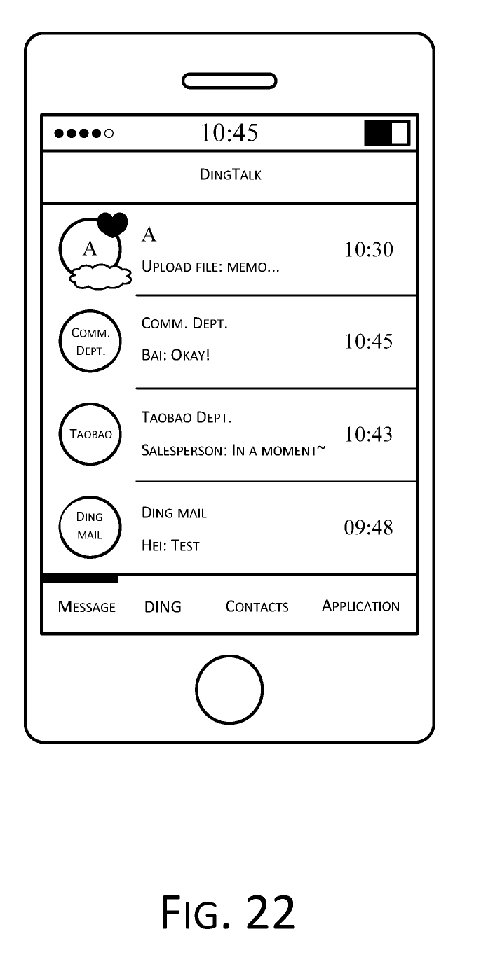

As shown in FIG. 22, a notification message about a file update operation in the shared cloud disk space is displayed on a message prompting page. At the same time, the notification message is distinctively prompted by a special follow identifier “♥” and the operation type identifier “cloud” or other patterns etc.

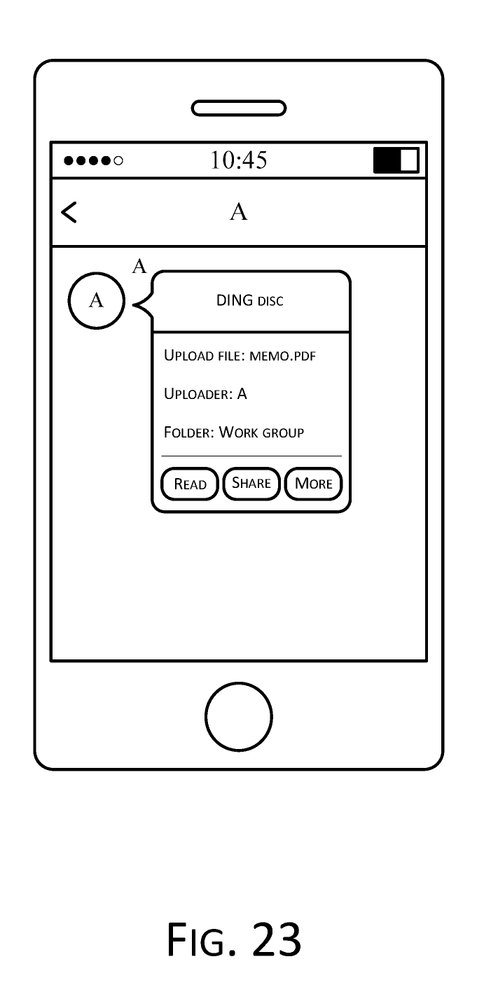

Furthermore, after the prompt is responded by the currently logged-in user, the page is switched to a message receiving window corresponding to the special follow object A shown in FIG. 23. In the message receiving window, the content of the notification message is displayed in a form such as “bubble box”, for example, the information of the file uploaded by A is shown in FIG. 23: “Upload file: memo.pdf”, “Uploader: A”, “Folder: Work Group” and other information. Certainly, in the message receiving window shown in FIG. 23, the entire or partial content of the uploaded file may be displayed, which is related to the predefined display strategy and the like.

In order to facilitate the operation of the currently logged-in user, since the content type of the notification message is the information of the updated file in the shared cloud disk space, a function icon for the file may be shown, for example, some function icons are shown under the file information shown in FIG. 23, such as “read”, “share” etc. When the user clicks on these function icons, the corresponding functions are directly executed in the current message receiving window and don't need to switch to the processing page of the cloud disk space, which helps to improve the user's operation effectiveness. Certainly, the currently logged-in user may also choose to switch to the cloud disk space to use the complete file processing function, which is not limited in the present disclosure.

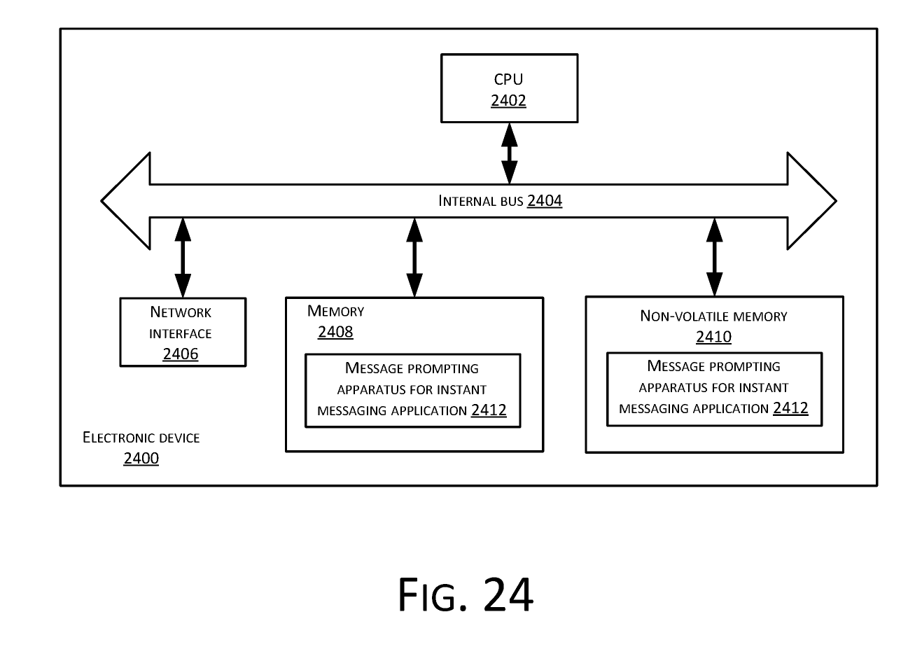

FIG. 24 shows a structural diagram of an electronic device 2400 according to an example embodiment of the present disclosure. Referring to FIG. 24, as for hardware, the electronic device 2400 includes a processor 2402, an internal bus 2404, a network interface 2406, a memory 2408, and a non-volatile memory 2410, and may also include hardware required by other services. The processor 2402 reads the corresponding computer program from the non-volatile memory 2410 into the memory 2408 and then runs to form a message prompting apparatus for instant messaging application 2412 on the logic level. Certainly, this disclosure does not exclude other implementations other than the software implementation, such as logic devices or a combination of hardware and software, etc. That is, the execution object of the following processing flows is not limited to each logic unit, and may be hardware or logic device.

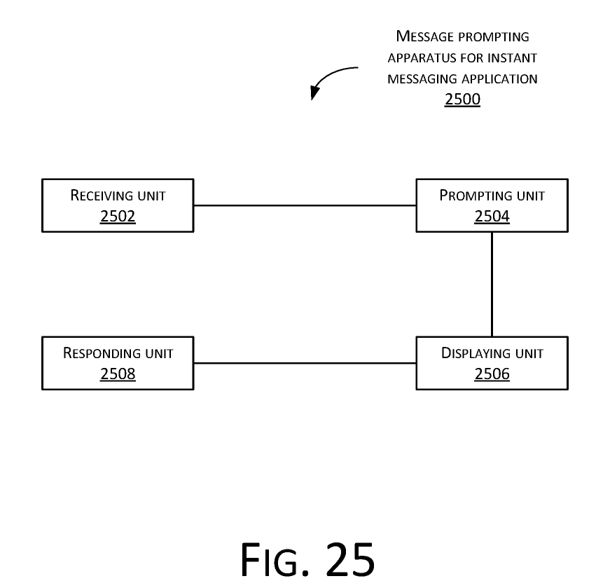

Referring to FIG. 25, in a software implementation, a message prompting apparatus for instant messaging application 2500 includes a receiving unit 2502 and a prompting unit 2504, wherein:

the receiving unit 2502 receives a notification message pushed by a server, wherein the notification message is correlated to preset operation executed by a special follow object of a currently logged-in user in the instant messaging application; wherein there is a first correlation between the currently logged-in user and the special follow object in the preset relational dimension, and the first correlation is different from a second correlation between the currently logged-in user and another object in the preset relational dimension; and

the prompting unit 2504 prompts the notification message through a first prompting manner, wherein the first prompting manner is different from a second prompting manner used for the group message not related to the special follow object.

Optionally, the prompting unit 2504 further uses the notification message as an instant messaging message which is sent by the special follow object, prompting the notification message, and displaying at least one of the following in a correlated display area of the notification message: a special follow identifier, an operation type identifier.

Optionally, the operation object of the preset operation includes: a mail system or a shared cloud disk space correlated to the instant messaging application; and the preset operation includes: sending an email to a currently logged-in user through the mail system or an update operation for the file in the shared cloud disk space;

The notification message includes the content of the email or the information of the updated file in the shared cloud disk space.

Optionally, the message prompting apparatus for instant messaging application 2500 also includes:

a displaying unit 2506 that displays the content of the notification message in the message receiving window corresponding to the special follow object after the receiving prompt is responded and displays the function icon of the content type of the notification message in the display area according to the content type of the notification message; and

a responding unit 2508 that executes a response operation for the preset operation in the message receiving window according to the selected function icon.

In a typical configuration, the computing device includes one or more processors (CPU), an input/output interface, a network interface, and a memory.

Memory includes non-volatile memory, random access memory (RAM) and/or non-volatile memory in a form of computer-readable media such as read-only memory (ROM) or flash RAM. Memory is an example of a computer-readable medium.

Computer-readable media, including both permanent and non-permanent media, removable and non-removable media, may be stored by any method or technology for information storage. The information may be computer-readable instructions, data structures, modules of programs, or other data. Examples of computer storage media include, but are not limited to, a Parameter Random Access Memory (PRAM), a Static Random Access Memory (SRAM), a Dynamic Random Access Memory (DRAM), other types of Random Access Memory (RAM), a Read Only Memory such as ROM, an Electrically Erasable Programmable Read Only Memory (EEPROM), a flash memory or other memory technologies, CD-ROM, DVD, or other optical storage, magnetic cassettes, magnetic tape, magnetic disk storage or other magnetic storage devices, or any other non-transitory medium, may be used to store information that may be accessed by a computing device. As defined herein, computer-readable media do not include transitory media such as modulated data signals and carriers.

It also needs to be noted that the terms “comprise,” “include,” or the like, are intended to cover a non-exclusive inclusion so that a process, method, product, or apparatus that comprises a series of elements includes not only those elements but also other elements not specifically listed, or also includes inherent elements of such process, method, product, or apparatus. Without further limitations, an element limited by the statement “including a . . . ” does not exclude the existence of additional identical elements in the process, method, product, or apparatus.

The above is only the example embodiments of the present disclosure and are not intended to limit the present disclosure. Any modifications, equivalent substitutions, improvements, etc. within the spirit and principle of the present disclosure should be included in the present disclosure within the scope of protection.

The present disclosure may further be understood with clauses as follows.

Clause 1: A group message prompting method for an instant messaging application comprising:

receiving a group message pushed by a server;

determining whether the group message is related to a special follow object of a currently logged-in user in the instant messaging application, there being a first correlation between the currently logged-in user and the special follow object in a preset relational dimension, and the first correlation being different from a second correlation between the currently logged-in user and another object in the preset relational dimension; and

prompting the group message through a first prompting manner when the group message is related to the special follow object, the first prompting manner being different from a second prompting manner used for a group message not related to the special follow object.

Clause 2: The method of clause 1, wherein the preset relational dimension includes at least one of the following:

a membership structure of an organization to which the currently logged-in user belongs; and

a degree of concern for each object from the currently logged-in user.

Clause 3: The method of clause 2, wherein:

when the preset relational dimension is the membership structure, the special follow object is a member of the organization, and the correlation between the special follow object and the currently logged-in user meets at least one of the following:

a job level of the special follow object is higher than that of the currently logged-in user in the membership structure;

a work content of the special follow object is consistent with a work content of the currently logged-in user; and

a work content of the special follow object has a synergic relationship with the work content of the currently logged-in user.

Clause 4: The method of clause 3, wherein the determining whether the group message is related to the special follow object of the currently logged-in user in the instant messaging application further includes:

determining whether a sender of the group message is the special follow object.

Clause 5: The method of clause 2, wherein:

when the preset relational dimension is the degree of concern, the special follow object is the object whose degree of concern from the currently logged-in user reaches a preset degree of concern.

Clause 6: The method of clause 5, wherein the determining whether the group message is related to the special follow object of the currently logged-in user in the instant messaging application further includes:

determining whether a content of the group message includes a keyword related to the special follow object.

Clause 7: The method of clause 5, wherein the special follow object is determined by at least one of the following information about the currently logged-in user:

a work content; and

historical behavior data.

Clause 8: The method of clause 1, further comprising:

sticking the group message related to the special follow object on a message prompting page of the instant messaging application.

Clause 9: The method of clause 1, further comprising:

displaying an unread group message in response to determining that there is the unread group message related to the special follow object when a display page of the group message is triggered.

Clause 10: The method of clause 9, wherein displaying the unread group message related to the special follow object includes:

extracting all unread group messages related to the special follow object and displaying the all unread group message in a concentrated location; or

moving the display page to the unread group message related to the special follow object.

Clause 11: The method of clause 1, further comprising:

obtaining a correlation between the currently logged-in user and all objects in the preset relational dimension; and

determining the special follow object, the correlation between the special follow object and the currently logged-in user being the first correlation, and the correlation between the another object and the currently logged-in user being the second correlation.

Clause 12: The method of clause 1, further comprising:

receiving the special follow object of the currently logged-in user pushed by the server, wherein the special follow object is determined by a server according to a correlation between the currently logged-in user and all objects in the preset relational dimension.

Clause 13: The method of clause 1, wherein the instant messaging application is an enterprise instant messaging application.

Clause 14: A group message prompting apparatus for an instant messaging application comprising:

a receiving unit that receives a group message pushed by a server;

a determining unit that determines whether the group message is related to a special follow object of a currently logged-in user in the instant messaging application, there being a first correlation between the currently logged-in user and the special follow object in a preset relational dimension, and the first correlation being different from a second correlation between the currently logged-in user and another object in the preset relational dimension; and

a prompting unit that prompts the group message through a first prompting manner when the group message is related to the special follow object, the first prompting manner being different from a second prompting manner used for a group message not related to the special follow object.

Clause 15: The apparatus of clause 14, wherein the preset relational dimension includes at least one of the following:

a membership structure of an organization to which the currently logged-in user belongs; and

a degree of concern for each object from the currently logged-in user.

Clause 16: The apparatus of clause 15, wherein:

when the preset relational dimension is the membership structure, the special follow object is a member of the organization, and the correlation between the special follow object and the currently logged-in user meets at least one of the following:

a job level of the special follow object is higher than that of the currently logged-in user in the membership structure;

a work content of the special follow object is consistent with a work content of the currently logged-in user; and

a work content of the special follow object has a synergic relationship with the work content of the currently logged-in user.

Clause 17: The apparatus of clause 15, wherein the determining unit further determines whether a sender of the group message is the special follow object.

Clause 18: The apparatus of clause 15, wherein:

when the preset relational dimension is the degree of concern, the special follow object is the object whose degree of concern from the currently logged-in user reaches a preset degree of concern.

Clause 19: The apparatus of clause 18, wherein the determining unit further determines whether a content of the group message includes a keyword related to the special follow object.

Clause 20: The apparatus of clause 18, wherein the special follow object is determined by at least one of the following information about the currently logged-in user:

a work content; and

historical behavior data.

Clause 21: The apparatus of clause 14, further comprising a sticking unit that sticks the group message related to the special follow object on a message prompting page of the instant messaging application.

Clause 22: The apparatus of clause 14, further comprising a displaying unit that displays an unread group message in response to determining that there is the unread group message related to the special follow object when a display page of the group message is triggered.

Clause 23: The apparatus of clause 22, wherein the displaying unit further:

extracts all unread group messages related to the special follow object and displaying the all unread group message in a concentrated location; or

moves the display page to the unread group message related to the special follow object.

Clause 24: The apparatus of clause 14, further comprising:

an obtaining unit that obtains a correlation between the currently logged-in user and all objects in the preset relational dimension; and

the determining unit that determines the special follow object, the correlation between the special follow object and the currently logged-in user being the first correlation, and the correlation between the another object and the currently logged-in user being the second correlation.

Clause 25: The apparatus of clause 14, further comprising an object receiving unit that receives the special follow object of the currently logged-in user pushed by the server, wherein the special follow object is determined by a server according to a correlation between the currently logged-in user and all objects in the preset relational dimension.

Clause 26: The apparatus of clause 14, wherein the instant messaging application is an enterprise instant messaging application.

Clause 27: A message prompting method for an instant messaging application comprising:

receiving a communication message pushed by a server, the communication message being sent by a pre-correlated user and having a plurality of receiving users;

determining whether the communication message is related to a special follow object of a currently logged-in user in the instant messaging application, there being a first correlation between the currently logged-in user and the special follow object in a preset relational dimension, and the first correlation is different from a second correlation between the currently logged-in user and another object in the preset relational dimension; and

prompting the communication message through a first prompting manner when the communication message is related to the special follow object, the first prompting manner being different from a second prompting manner used for a communication message not related to the special follow object.

Clause 28: A message prompting apparatus for an instant messaging application comprising:

a receiving unit that receives a communication message pushed by a server, the communication message being sent by a pre-correlated user and having a plurality of receiving users;

a determining unit that determines whether the communication message is related to a special follow object of a currently logged-in user in the instant messaging application, there being a first correlation between the currently logged-in user and the special follow object in a preset relational dimension, and the first correlation is different from a second correlation between the currently logged-in user and another object in the preset relational dimension; and

a prompting unit that prompts the communication message through a first prompting manner when the communication message is related to the special follow object, the first prompting manner being different from a second prompting manner used for a communication message not related to the special follow object.

Clause 29: A message prompting method for an instant messaging application comprising:

receiving a notification message pushed by a server, the notification message relating to a preset operation executed by a special follow object of a currently logged-in user in the instant messaging application, there being a first correlation between the currently logged-in user and the special follow object in a preset relational dimension, and the first correlation being different from a second correlation between the currently logged-in user and another object in the preset relational dimension; and

prompting the notification message through a first prompting manner, first prompting manner being different from a second prompting manner used for a notification message not related to the special follow object.

Clause 30: The method of clause 29, wherein the prompting the notification message through the first prompting manner includes:

treating the notification message as an instant messaging message of which the special follow object is the sender;

prompting to receive the notification message; and

displaying at least one of the followings in a display area correlated to the notification message:
a special follow identifier; and
an operation type identifier.

Clause 31: The method of clause 29, wherein:

the operation object of the preset operation includes a mail system or a shared cloud disk space correlated to the instant messaging application;

the preset operation includes sending an email to a currently logged-in user through the mail system or an update operation for a file in the shared cloud disk space; and
the notification message includes: a content of the email, or information of the updated files in the shared cloud disk space.

Clause 32: The method of clause 29, further comprising:

displaying a content of the notification message in a message receiving window corresponding to the special follow object after the prompting is responded;

displaying a function icon corresponding to a type of the content type according to the type of the content of the notification message; and
executing a response operation for the preset operation in the message receiving window according to a selected function icon.

Clause 33: A message prompting apparatus for an instant messaging application comprising:

a receiving unit that receives a notification message pushed by a server, the notification message relating to a preset operation executed by a special follow object of a currently logged-in user in the instant messaging application, there being a first correlation between the currently logged-in user and the special follow object in a preset relational dimension, and the first correlation being different from a second correlation between the currently logged-in user and another object in the preset relational dimension; and

a prompting unit that prompts the notification message through a first prompting manner, first prompting manner being different from a second prompting manner used for a notification message not related to the special follow object.

Clause 34: The apparatus of clause 33, wherein the prompting unit further:

Treats the notification message as an instant messaging message of which the special follow object is the sender;

prompts to receive the notification message; and

displays at least one of the followings in a display area correlated to the notification message:
a special follow identifier; and
an operation type identifier.

Clause 35: The apparatus of clause 33, wherein:

an operation object of the preset operation includes a mail system or a shared cloud disk space correlated to the instant messaging application;

the preset operation includes sending an email to a currently logged-in user through the mail system or an update operation for a file in the shared cloud disk space; and

the notification message includes: a content of the email, or information of the updated files in the shared cloud disk space.

Clause 35: The apparatus of clause 33, further comprising:

a displaying unit that displays a content of the notification message in a message receiving window corresponding to the special follow object after the prompting is responded, and displays a function icon corresponding to a type of the content type according to the type of the content of the notification message; and

a responding unit that executes a response operation for the preset operation in the message receiving window according to a selected function icon.

What is claimed is:

1. A method comprising:
receiving a group message;
determining that the group message is related to a special follow object of a currently logged-in user in an instant messaging application, there being a first correlation between the currently logged-in user and the special follow object in a preset relational dimension, and the first correlation being different from a second correlation between the currently logged-in user and another object in the preset relational dimension; and
prompting the group message through a first prompting manner, the first prompting manner being different from a second prompting manner used for a group message not related to the special follow object.

2. The method of claim 1, wherein the group message is pushed by a server.

3. The method of claim 1, wherein the preset relational dimension includes a membership structure of an organization to which the currently logged-in user belongs.

4. The method of claim 3, wherein:
the special follow object is a member of the organization, and the correlation between the special follow object and the currently logged-in user meets at least one of the following:
a job level of the special follow object is higher than that of the currently logged-in user in the membership structure;
a work content of the special follow object is consistent with a work content of the currently logged-in user; and
a work content of the special follow object has a synergic relationship with the work content of the currently logged-in user.

5. The method of claim 1, wherein the determining that the group message is related to the special follow object of the currently logged-in user in the instant messaging application further includes:
determining that a sender of the group message is the special follow object.

6. The method of claim 1, wherein:
the preset relational dimension includes a degree of concern for each object from the currently logged-in user; and
the special follow object is the object whose degree of concern from the currently logged-in user reaches a preset degree of concern.

7. The method of claim 1, wherein the determining that the group message is related to the special follow object of the currently logged-in user in the instant messaging application further includes:
determining that a content of the group message includes a keyword related to the special follow object.

8. The method of claim 1, further comprising determining the special follow object according to at least one of the following information of the currently logged-in user:
a work content; and
historical behavior data.

9. The method of claim 1, further comprising:
sticking the group message related to the special follow object on a message prompting page of the instant messaging application.

10. The method of claim 1, further comprising:
displaying an unread group message in response to determining that the unread group message is related to the special follow object when a display page of the group message is triggered.

11. The method of claim 10, wherein displaying the unread group message related to the special follow object includes:
extracting one or more unread group messages related to the special follow object and displaying the one or more unread group message in a concentrated location.

12. The method of claim 10, wherein displaying the unread group message related to the special follow object includes:
moving the display page to the unread group message related to the special follow object.

13. The method of claim 1, further comprising:
obtaining a correlation between the currently logged-in user and all objects in the preset relational dimension; and
determining the special follow object that has the first correlation with the currently logged-in user being the first correlation.

14. The method of claim 1, further comprising:
receiving the special follow object pushed by the server, wherein the special follow object is determined by a server according to a correlation between the currently logged-in user and all objects in the preset relational dimension.

15. The method of claim 1, wherein the instant messaging application is an enterprise instant messaging application.

16. A method comprising:
receiving a communication message, the communication message being sent by a pre-correlated user and having a plurality of receiving users;
determining that the communication message is related to a special follow object of a currently logged-in user in the instant messaging application, there being a first correlation between the currently logged-in user and the special follow object in a preset relational dimension, and the first correlation being different from a second correlation between the currently logged-in user and another object in the preset relational dimension; and
prompting the communication message through a first prompting manner, the first prompting manner being different from a second prompting manner used for a communication message not related to the special follow object.

17. A method comprising:
receiving a notification message, the notification message relating to a preset operation executed by a special follow object of a currently logged-in user in the instant messaging application, there being a first correlation between the currently logged-in user and the special follow object in a preset relational dimension, and the first correlation being different from a second correlation between the currently logged-in user and another object in the preset relational dimension; and
prompting the notification message through a first prompting manner, first prompting manner being different from a second prompting manner used for a group message not related to the special follow object.

18. The method of claim 17, wherein the prompting the notification message through the first prompting manner includes:
treating the notification message as an instant messaging message of which the special follow object is the sender;
prompting to receive the notification message; and
displaying at least one of the followings in a display area correlated to the notification message:
a special follow identifier; and
an operation type identifier.

19. The method of claim 17, wherein:
an operation object of the preset operation includes a mail system or a shared cloud disk space correlated to the instant messaging application;
the preset operation includes sending an email to a currently logged-in user through the mail system or an update operation for a file in the shared cloud disk space; and
the notification message includes: a content of the email, or information of the updated files in the shared cloud disk space.

20. The method of claim 17, further comprising:
displaying a content of the notification message in a message receiving window corresponding to the special follow object after the prompting is responded;
displaying a function icon corresponding to a type of the content type according to the type of the content of the notification message; and
executing a response operation for the preset operation in the message receiving window according to a selected function icon.
